(19) United States
(12) Patent Application Publication
(10) Pub. No.: US 2013/0106779 A1
(43) Pub. Date: May 2, 2013

(54) NOISE COMPENSATION TECHNIQUES FOR CAPACITIVE TOUCH SCREEN SYSTEMS

(71) Applicant: ANALOG DEVICES, INC., Norwood, MA (US)

(72) Inventors: Enrique COMPANY BOSCH, Alginet (ES); Pedro Tomas MOLINA, Castellon de la Plana (ES); John CLEARY, Kilmallock (IE); Alberto CARBAJO GALVE, San Antonio de Benageber (ES)

(73) Assignee: ANALOG DEVICES, INC., Norwood, MA (US)

(21) Appl. No.: 13/665,425

(22) Filed: Oct. 31, 2012

Related U.S. Application Data
(60) Provisional application No. 61/553,614, filed on Oct. 31, 2011.

(51) Int. Cl. G06F 3/044

(52) U.S. Cl. 345/174

(57) ABSTRACT

Noise compensation techniques for capacitive touch screen systems. The techniques may include measurement operations that may measure coupled noise frequencies that may be induced on a capacitive touch screen. Noise measurement techniques may include driving a stimulus voltage(s) to a conductor(s) of a capacitive touch screen and sampling return signals from a touch screen conductor(s). Noise measurement techniques may further include sampling ambient return signals from a touch screen conductor(s) in the absence of a stimulus voltage(s). Coupled noise frequencies may also be calculated from a first measured noise frequency. A touch screen control system may use measured or calculated coupled noise frequencies to configure operational parameters that may compensate for the coupled noise during operation of the capacitive touch screen.

### RELATED APPLICATION

This application claims the benefit of priority afforded by U.S. provisional patent application Ser. No. 61/553,614, entitled “Noise Compensation Techniques For Capacitive Touch Screen Systems,” filed on Oct. 31, 2011, the content of which is incorporated herein in its entirety.

### BACKGROUND

A capacitive touch screen is an electronic device that registers touch operations performed on the screen. Generally, the structure of a capacitive touch screen is well-known. A capacitive touch screen may include row and column conductors having conductive properties. The rows and columns may be separated by a dielectric material which creates a capacitance at the intersection of each row and column conductor.

Operation of the capacitive touch screen is managed by a control system. The control system injects an electric input signal to excite conductive rows or columns. The excited rows or columns create an electrostatic field about the surface of the touch screen. As a user touches a point or multiple points on the touch screen, the electrostatic field changes. The system measures the field changes and processes the measurements to determine touch locations or touch gestures.

Capacitive touch screens are used in a variety of applications including automotive, aviation, marine, and consumer electronic applications. Electromagnetic noise is induced on capacitive touch screen systems from a variety of sources. Such noise may originate from sources including switching power supplies, refresh cycles of co-located LCD display panels, electrical coupling between the layers of the capacitive touch screen, and operating environments. The noise is referred to generally as “coupled” noise. Coupled noise induced on a touch screen may cause the touch screen control system to identify false touches or determine incorrect touch locations or touch gestures for touch operations. The negative effects caused by coupled noise on a touch screen system may increase in kind with the size of the screen, the refresh or scan rate of the screen, or the content displayed on the screen.

Accordingly, there is a need in the art for noise compensation techniques for control of capacitive touch screen systems.

### BRIEF DESCRIPTION OF THE DRAWINGS

FIGS. 1A-1B illustrate measurement systems according to an embodiment of the present invention.

FIG. 2A-2B illustrate a self-measurement circuits according to an embodiment of the present invention.

FIG. 3 illustrates a method for performing a self-measurement of capacitive touch screen conductors according to an embodiment of the present invention.

FIG. 4 illustrates a mutual-measurement circuit according to an embodiment of the present invention.

FIG. 5 illustrates a method for performing a mutual measurement of capacitive touch screen conductors according to an embodiment of the present invention.

FIG. 6 illustrates a control system for a capacitive touch screen according to an embodiment of the present invention.

FIG. 7 illustrates a method for controlling a capacitive touch screen system according to an embodiment of the present invention.

FIG. 8 illustrates a method for determining an optimum integration time for control of a capacitive touch screen system according to an embodiment of the present invention.

FIG. 9 illustrates a method for performing parasitic capacitance calibration according to an embodiment of the present invention.

### DETAILED DESCRIPTION

Embodiments of the present invention provide noise compensation techniques for capacitive touch screen systems. The techniques may include measurement operations that may measure coupled noise frequencies that may be induced on a capacitive touch screen. Noise measurement techniques may include driving a stimulus voltage(s) to a conductor(s) of a capacitive touch screen and sampling return signals from a touch screen conductor(s). Noise measurement techniques may further include sampling ambient return signals from a touch screen conductor(s) in the absence of a stimulus voltage(s). Coupled noise frequencies may also be calculated from a first measured noise frequency. A touch screen control system may use measured or calculated coupled noise frequencies to configure operational parameters that may compensate for the coupled noise during operation of the capacitive touch screen.

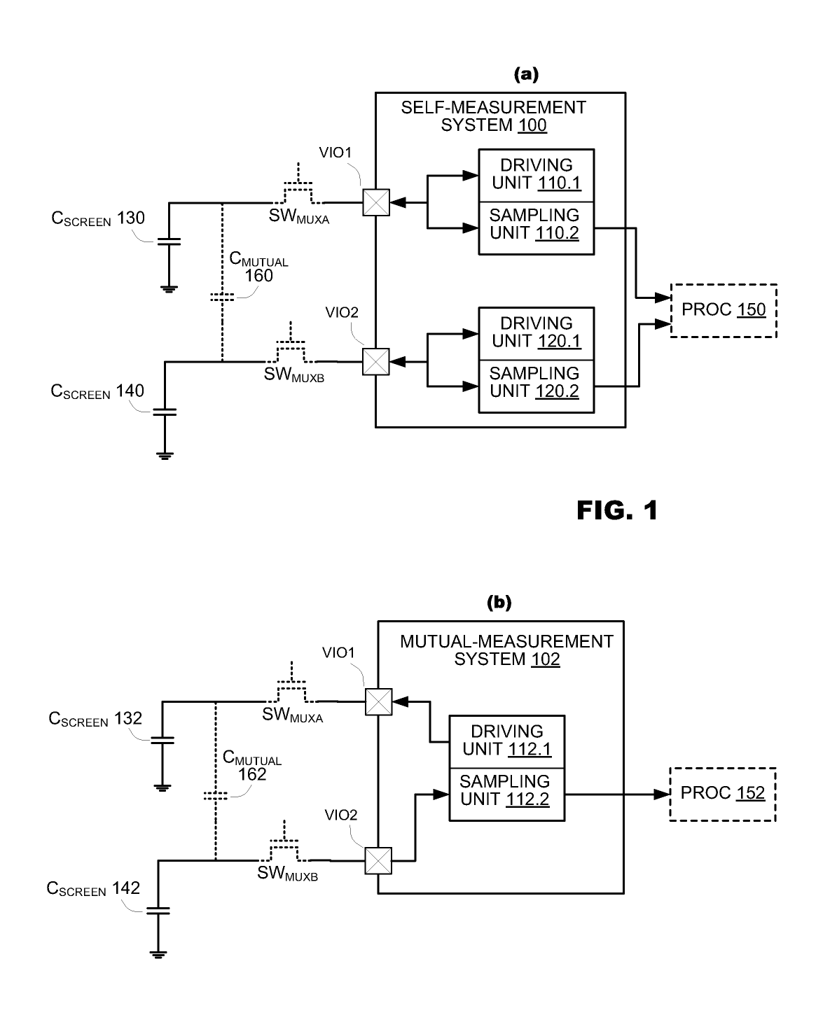

FIG. 1A illustrates a self-measurement system 100 according to an embodiment of the present invention. The self-measurement system 100 may be embodied in a touch screen control system, for measuring noise from conductors of a capacitive touch screen. The self-measurement system 100 may include a pair of input/output (“I/O”) terminals VIO1, VIO2, a first driving and sampling unit 110.1, 110.2, and a second driving and sampling unit 120.1, 120.2. The first driving unit 110.1 may drive stimulus voltages to the first I/O terminal VIO1. The first sampling unit 110.2 may capture return charges from the first I/O terminal VIO1. The second driving unit 120.1 drive stimulus voltages to the second I/O terminal VIO2. The second sampling unit 120.2 may capture return charges from the second I/O terminal VIO2.

In the configuration illustrated in FIG. 1A, the first I/O terminal VIO1 may be coupled to a first touch screen conductor, which is shown as a capacitive load C_{SCREEN} 130. The first touch screen conductor C_{SCREEN} 130 may correspond to any row or column conductor of the capacitive touch screen. The second I/O terminal VIO2 may be coupled to a second touch screen conductor, which is shown as a capacitive load C_{SCREEN} 140. The second touch screen conductor C_{SCREEN} 140 may correspond to any row or column conductor of the capacitive touch screen, or it may correspond to a reference capacitance coupled to the capacitive touch screen. Intersections of a first touch screen conductor C_{SCREEN} 130 with a second touch screen conductor C_{SCREEN} 140 may be termed “crosspoints” for the touch screen. The system 100 may connect to any conductor of the touch screen to perform a self-measurement operation. The measurement system 100 may connect to the conductors via multiplexer switches such as switches SW_{MUXA} and SW_{MUXB}. A processor, which is shown as processor 150, may manage operation of the measurement system 100 and characterize coupled noise measured by the system. During measurement operations, the processor 150 may also control the multiplexer switches SW_{MUXA} and SW_{MUXB} through control lines (not shown).

During a self-measurement operation, first stimulus voltages may be driven from each of the first and second driving units 110.1, 120.1 to the first and second I/O terminals VIO1, VIO2. The respective first stimulus voltages may charge the first and second touch screen conductors C_{SCREEN} 130, 140. First return charges may then be captured from the first and second I/O terminals VIO1, VIO2 by the respective first and second sampling units 110.2, 120.2, which may store the first return charges. The first and second driving units 110.1, 120.1 may drive second stimulus voltages to the first and second I/O terminals VIO1, VIO2, which may charge the first and second touch screen conductors C_{SCREEN} 130, 140. Second return charges may be captured from the first and second I/O terminals by the first and second sampling units 110.1, 110.2, which may store the second return charges. Each sampling unit 110.1, 110.2 may transfer its respective first and second return charge to the processor 150, which may calculate an overall measurement result from the first and second return charges.

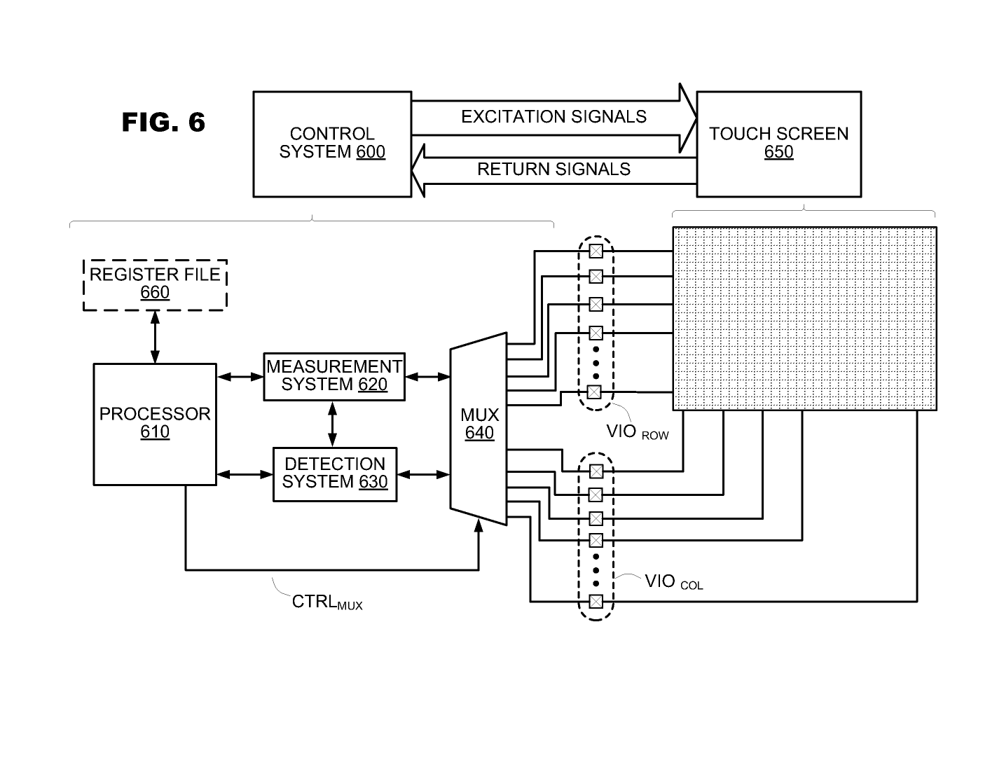

The self-measurement system 100 may perform measurement operations according to a predetermined integration time as set by the processor 150. The integration time may relate to a coupled noise frequency to be measured for a given measurement operation. Depending on the mode of operation, the inverse of the integration time may equal the noise frequency to be measured. The integration time may be used to control driving and capturing time periods for measurement operations. Further explanation of the integration time in relation to touch detection and measurement operations is discussed below for FIG. 6.

As shown in FIG. 1(a), the system includes a mutual capacitance C_{MUTUAL} 160 coupled between the screen conductors C_{SCREEN} 130, 140. The mutual capacitance C_{MUTUAL} may represent the cross point capacitance that is inherent between the first touch screen conductor and the second touch screen conductor. The mutual capacitance C_{MUTUAL} may change when a user touches the touch screen.

In an embodiment, each driving unit 110.1, 120.1 may include a switching system to couple respective first and second stimulus voltages to the first and second I/O terminals VIO1, VIO2. In another embodiment, each driving unit 110.1, 120.1 may include a multiplexer to couple respective first and second stimulus voltages to the first and second I/) terminals VIO1, VIO2.

In an embodiment, each respective sampling unit 110.2, 120.2 may include a single-ended operational amplifier (“op-amp”) to capture the respective first and second return charges from the first and second I/O terminals VIO1, VIO2. In another embodiment, each respective sampling unit 110.2, 120.2 may include a sample-and-hold unit to capture the respective first and second return charges from the first and second I/O terminals VIO1, VIO2. In yet another embodiment, the first and second sampling units 110.2, 120.2 may be combined into a single sampling unit (not shown) using a differential op-amp to capture the respective first and second return charges from the first and second I/O terminals VIO1, VIO2.

FIG. 1B illustrates a mutual-measurement system 102 according to an embodiment of the present invention. The mutual-measurement system 100 may be embodied in a touch screen control system, for measuring noise from conductors of a capacitive touch screen. The mutual-measurement system 102 may include a pair of I/O terminals VIO1, VIO2, and driving and sampling unit 112.1, 112.2. The driving unit 112.1 may drive stimulus voltages to the first I/O terminal VIO1. The sampling unit 112.2 may capture return charges from the second I/O terminal VIO1.

In the configuration illustrated in FIG. 1B, the first I/O terminal VIO1 may be coupled to a first touch screen conductor, which is shown as a capacitive load C_{SCREEN} 132. The second I/O terminal VIO2 may be coupled to a second touch screen conductor, which is shown as a capacitive load C_{SCREEN} 142. The first and second touch screen conductors C_{SCREEN} 132, 142 may correspond to any row or column conductor of the capacitive touch screen. The mutual-measurement system 102 may connect to any conductor of the touch screen to perform a measurement operation. The mutual-measurement system 102 may connect to the touch screen conductors via multiplexer switches such as switches SW_{MUXA} ^{and SW}_{MUXB}. A processor, which is shown as processor 152, may manage operation of the measurement system 100 and characterize coupled noise measured by the system 102. During measurement operations, the processor 152 may also control the multiplexer switches SW_{MUXA} and SW_{MUXB} through control lines (not shown). A mutual capacitance C_{MUTUAL} 162 may be coupled between the screen conductors C_{SCREEN} 132, 142.

During a mutual-measurement operation, a first stimulus voltage may be driven from the driving unit 112.1 to the first I/O terminal VIO1. The first stimulus voltage may charge the first touch screen conductor C_{SCREEN} 132. The charge may be transferred to the second touch screen conductor C_{SCREEN} 142 through capacitive coupling (represented by C_{MUTUAL}). A first return charge may be captured from the second I/O terminal VIO2 by the sampling unit 112.2, which may store the first return charge. The driving unit 112.1 may then drive a second stimulus voltage to the first I/O terminal VIO1, which may charge the first touch screen conductor C_{SCREEN} 132. The charge may be transferred to the second touch screen conductor C_{SCREEN} 142 through capacitive coupling. A second return charge may be captured from the second I/O terminal by the sampling unit 112.2, which may store the second return charge. The first return charge and/or the second return charge may be used to calculate the changes of the screen conductor C_{SCREEN} 132, screen conductor C_{SCREEN} 142 and/or the mutual capacitance C_{MUTUAL}. The output from the first return charge and/or the second return charge may be proportional to the mutual capacitance C_{MUTUAL}. In one embodiment, the sampling unit 112.2 may transfer the first and second return charge to the processor 152, which may calculate an overall measurement result for the mutual-measurement operation. The mutual-measurement system 102 may also perform measurement operations according to a predetermined integration time as set by the processor 152 to measure various coupled noise frequencies.

In an embodiment, the driving unit 112.1 may include a switching system to couple the first and second stimulus voltages to the first I/O terminal VIO1. In another embodiment, the driving unit 112.1 may include a multiplexer to couple the first and second stimulus voltages to the first I/O terminal VIO1,

In an embodiment, the sampling unit 112.2 may include a pair of single-ended op-amps to capture the first and second return charges from the second I/O terminal VIO2. In another embodiment, the sampling unit 112.2 may include a pair of sample-and-hold units to capture the first and second return charges from the second I/O terminal VIO2. In yet another embodiment, the sampling unit 112.2 may include a differential op-amp to capture the first and second return charges from the second I/O terminal VIO2.

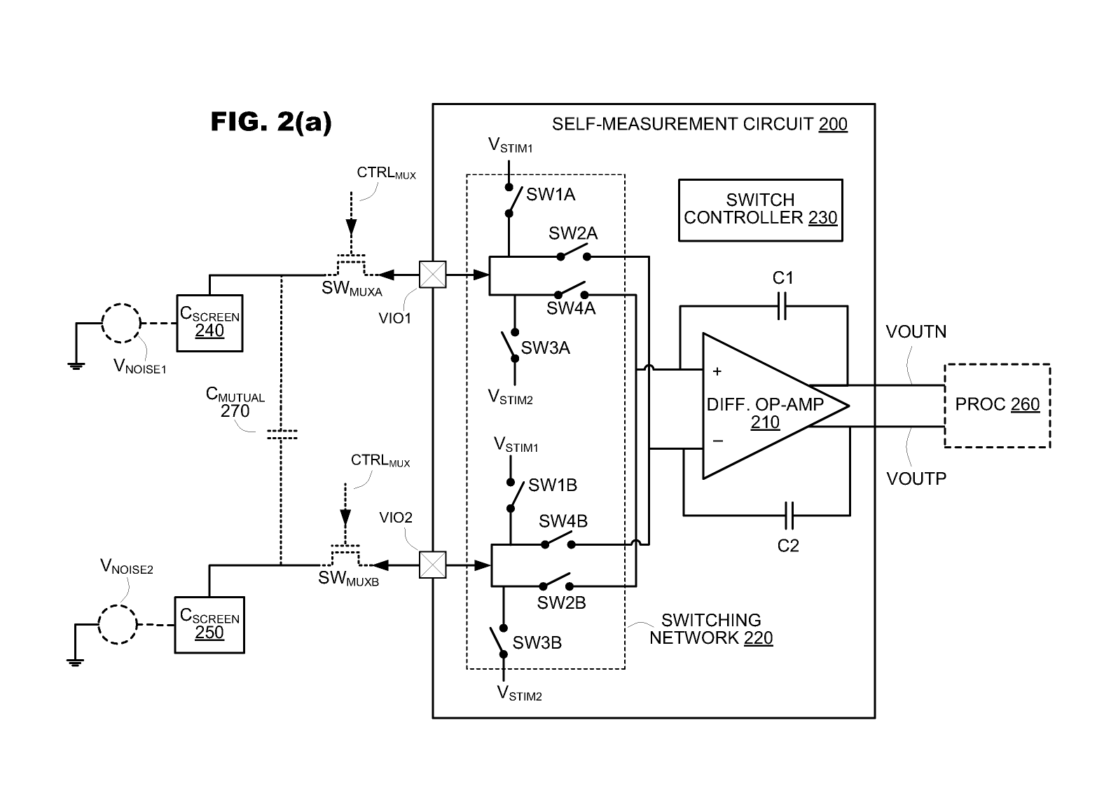

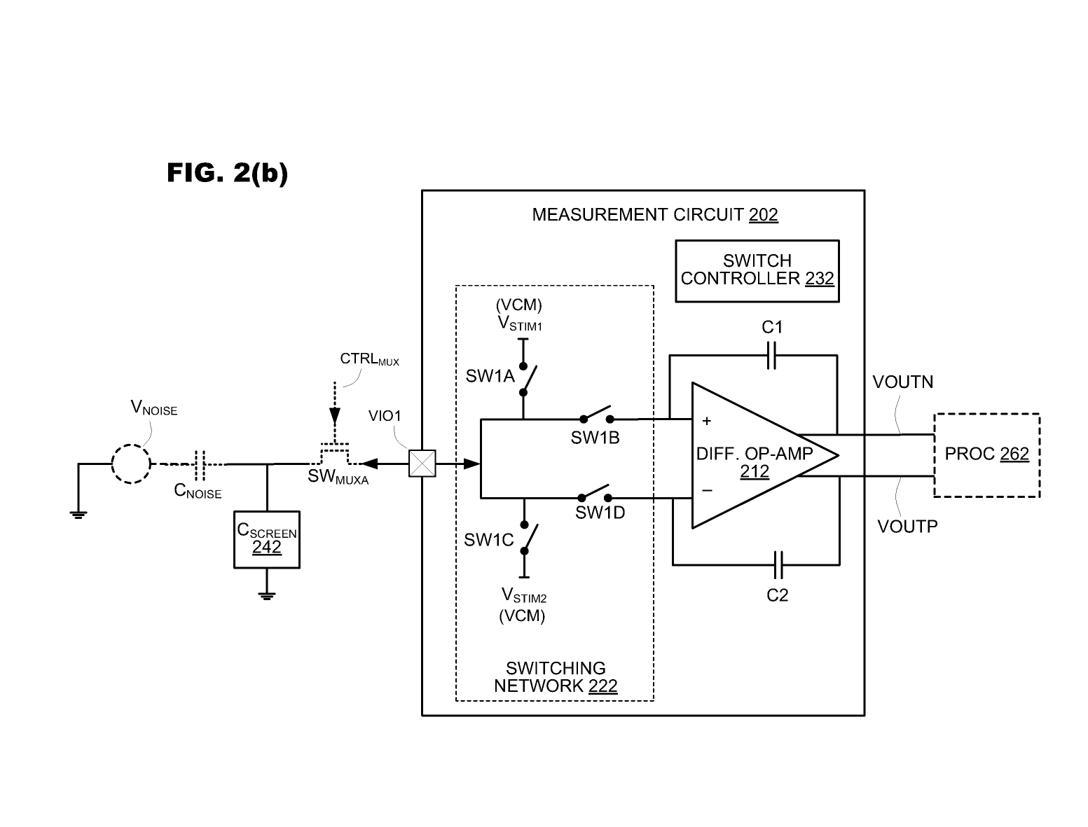

FIG. 2(a) illustrates a self-measurement circuit 200 according to an embodiment of the present invention. The self-measurement circuit 200 may be embodied in a touch screen control system, for measuring noise from conductors of a capacitive touch screen. As illustrated in FIG. 2(a), the self-measurement circuit 200 may include a pair of I/O terminals VIO1, VIO2, a differential op-amp 210, and a switching network 220 operating under control of a switch controller 230. In the configuration illustrated in FIG. 1, the first I/O terminal VIO1 may be coupled to a first touch screen conductor being measured, which is shown as a capacitive load C_{SCREEN} 240. The second I/O terminal VIO2 may be coupled to a second touch screen conductor, which is shown as a capacitive load C_{SCREEN} 250. A mutual capacitance C_{MUTUAL} 270 may be coupled between the capacitive load C_{SCREEN} 240 and the capacitive load C_{SCREEN} 250.

The switching network 220 may include a variety of switches. The switches may be provided in pairs SW1A/SW1B, SW2A/SW2B, SW3A/SW3B, and SW4A/SW4B. Within the first switch pair, switch SW1A may couple the first I/O terminal VIO1 to a first stimulus voltage V_{STIM1}. The second switch SW1B may couple the second I/O terminal VIO2 to the first stimulus voltage V_{STIM1}. Within the second switch pair, switch SW2A may couple the first I/O terminal VIO1 to an inverting input of the op-amp 210. The second switch SW2B may couple the second I/O terminal VIO2 to a non-inverting input of the op-amp 210. Within the third switch pair, switch SW3A may couple the first I/O terminal VIO1 to a second stimulus voltage V_{STIM2}. The second switch SW3B may couple the second I/O terminal VIO2 to the second stimulus voltage V_{STIM2}. Within the fourth switch pair, SW4A may couple the first I/O terminal VIO1 to the non-inverting input of the op-amp 210. The second switch SW4B may couple the second I/O terminal VIO2 to the inverting input of the op-amp 210. The switch controller 230 may manage the opening/closing timing of the various switches SW1A, SW1B, SW2A, SW2B, SW3A, SW3B, SW4A, and SW4B through control lines (not shown).

The op-amp 210 may have the non-inverting input terminal coupled to an inverting output VOUTN through a first integrating capacitor C1 and the inverting input coupled to a non-inverting output VOUTP through a second integrating capacitor C2. The capacitances for C1 and C2 may be approximately equal.

As discussed, the touch screen conductor C_{SCREEN} 240 may correspond to any row or a column conductor of a capacitive touch screen to be measured by the circuit 200. The touch screen conductor C_{SCREEN} 250 may correspond to another row or column conductor, or may be a reference capacitance coupled to the capacitive touch screen.

During operation, the self-measurement circuit 200 may connect to any conductor of the capacitive touch screen, either to measure the coupled noise present on the conductor or use it as a reference conductor for the measurement. The output of the op-amp 210 may be proportional to the capacitive load C_{SCREEN} 240 and/or the capacitive load C_{SCREEN} 250. The measurement circuit 200 may connect to the touch screen conductors via multiplexer switches such as SW_{MUXA} and SW_{MUXB}. A capacitive touch screen control system (e.g., system 600 of FIG. 6) may manage operation of the switches SW_{MUXA}, SW_{MUXB} using a control signal CTRL_{MUX} during self-measurement operations.

The self-measurement circuit 200 may perform a self-measurement operation through four control cycles. For the first control cycle, the first switch pair SW1A, SW1B may be closed to drive the first stimulus voltage V_{STIM1} to the first I/O terminal VIO1 and the first stimulus voltage V_{STIM1} to the second I/O terminal VIO2. This may charge the touch screen conductor C_{SCREEN} 240 to the first stimulus voltage V_{STIM1} and touch screen conductor C_{SCREEN} 250 to the first stimulus voltage V_{STIM1}. For the second cycle, the first switch pair SW1A, SW1B may be opened and the second switch pair SW2A, SW2B may be closed. A first return charge from the touch screen conductor C_{SCREEN} 240 may be captured at the inverting input terminal for op-amp 210 and a first return charge from the touch screen conductor C_{SCREEN} 250 may be captured at the non-inverting input terminal of the op-amp 210. The op-amp 210 may drive the respective voltages across the non-inverting and inverting output terminals VOUTP and VOUTN. The voltage from each output VOUTP and VOUTN may be stored in the respective integrating capacitors C2 and C1.

For the third cycle, the second switch pair SW2A, SW2B may be opened and the third switch pair SW3A, SW3B may be closed to drive the second stimulus voltage V_{STIM2} to the first I/O terminal VIO1 and the second stimulus voltage V_{STIM2} to the second I/O terminal VIO2. This may charge the touch screen conductor C_{SCREEN} 240 to the second stimulus voltage V_{STIM2} and the touch screen conductor C_{SCREEN} 250 to the second stimulus voltage V_{STIM2}. For the fourth cycle, the third switch pair SW3A, SW3B may be opened and the fourth switch pair SW4A, SW4B may be closed. A second return charge from the touch screen conductor C_{SCREEN} 240 may be captured at the inverting input terminal for op-amp 210 and a second return charge from the touch screen conductor C_{SCREEN} 250 may be captured at the non-inverting input terminal of the op-amp 210. The op-amp 210 may drive the respective voltages across the non-inverting and inverting output terminals VOUTP and VOUTN. The voltage from each output VOUTP and VOUTN may be stored in the respective integrating capacitors C2 and C1.

The voltages stored in the integrating capacitors C1 and C2 may represent the cumulative voltages as captured during the second and fourth cycles. The difference between the differential op-amp 210 outputs VOUTP and VOUTN may represent the result of the self-measurement operation. A processor, which is shown as processor 260, may calculate the difference between the op-amp 410 outputs VOUTP and VOUTN. The difference may relate to the capacitive difference of the touch screen conductor C_{SCREEN} 240 and the touch screen conductor C_{SCREEN} 250 and may relate to the voltage difference between V_{STIM1} and V_{STIM2}. The difference may be scaled in proportion to capacitive differences for the integrating capacitors C1 and/or C2 (capacitors C1 and C2 being approximately equal in size).

During each measurement cycle, voltage variations from coupled noise, represented by noise sources V_{NOISE1}, V_{NOISE2}, may also be induced on the touch screen conductor C_{SCREEN} 240 and/or the reference conductor C_{REF} 250. The coupled noise may be included in the overall result of the self-measurement operation (e.g., the difference between VOUTP and VOUTN). Because the first and second stimulus voltages V_{STIM1} and V_{STIM2} may be known for each measurement set, the difference between VOUTP and VOUTN may be further scaled to represent the voltage variations induced by V_{NOISE1} and V_{NOISE2}. The measured noise may be used by a touch screen control system (e.g., system 600 of FIG. 6) to configure operational parameters for touch detection operations, which may compensate for the measured noise.

Coupled noise may also be induced on the circuit 200 from bulk capacitances (not shown) that may exist in a touch screen control system (e.g., system 600 of FIG. 6). Bulk capacitances may result from capacitive coupling between various components of a touch screen control system. These system noises may be accounted for during a measurement operation using other scaling factors which may approximate the noise contributions from these noise sources. In various embodiments, multiple measurement operations may be performed to refine the noise measurements for the circuit 200. The noise measurements may be refined through a culmination of integration cycles for the integrating capacitors C1 and C2.

In FIG. 2(a) the first and second stimulus voltages V_{STIM1}, V_{STIM2} may be set to a common mode voltage (e.g. an AC ground voltage). Thus, in each cycle, the common mode voltage may be coupled to the respective touch screen conductor instead of applying an excitation voltage.

FIG. 2(b) illustrates a self-measurement circuit 202 according to an embodiment of the present invention. The self-measurement circuit 202 may be embodied in a touch screen control system, for measuring self capacitance of a capacitive touch screen. The self-measurement circuit 202 may use a number of switches to provide one or more reference voltages to a touch screen conductor and measure the voltage at the touch screen conductor using the non-inverting and/or the inverting inputs of an op-amp. The self-measurement circuit 202 may include a switch to sequentially connect the self-measurement circuit 202 to the first and second conductors of the touch screen or each conductor may be provided with the self-measurement circuit 202.

As illustrated in FIG. 2(b), the self-measurement circuit 202 may include a I/O terminal VIO1, a differential op-amp 212, and a switching network 222 operating under control of a switch controller 232. The I/O terminal VIO1 may be coupled to a touch screen conductor, which is shown as a capacitive load C_{SCREEN} 242. A voltage noise V_{NOISE} and/or capacitance noise C_{NOISE} may be coupled to the capacitive load C_{SCREEN} 242. The voltage noise V_{NOISE} and/or the capacitance noise may be due to switched-mode power supply noise and/or LCD noise introduced into the circuit. The effect of the finger touching the capacitive touch screen may change the voltage noise V_{NOISE} and/or the capacitance noise C_{NOISE}.

The switching network 222 may include a variety of switches. The switches may include switches SW1A, SW1B, SW1C and SW1D. Switch SW1A may couple a first stimulus voltage V_{STIM1} to the I/O terminal VIO1, Switch SW1B may couple the I/O terminal VIO1 to the non-inverting input of the op-amp 212. Switch SW1C may couple the second stimulus voltage V_{STIM2} to the I/O terminal VIO1, Switch SW1D may couple the I/O terminal VIO1 to the inverting input of the op-amp 212. The switch controller 232 may manage the opening/closing timing of the various switches SW1A, SW1B, SW1C and SW1D through control lines (not shown).

The op-amp 212 may have the non-inverting input terminal coupled to an inverting output VOUTN through a first integrating capacitor C1 and the inverting input coupled to a non-inverting output VOUTP through a second integrating capacitor C2. The capacitances for C1 and C2 may be approximately equal.

During operation, the self-measurement circuit 202 may connect to one conductor of the capacitive touch screen, to measure the coupled noise present on the conductor. The output of the op-amp 212 may be proportion to the capacitive load C_{SCREEN} 242, the voltage noise V_{NOISE} and/or capacitance noise C_{NOISE}. The measurement circuit 202 may connect to the touch screen conductors via a multiplexer switch, such as SW_{MUXA}. A capacitive touch screen control system (e.g., system 600 of FIG. 6) may manage operation of the switch SW_{MUXA} using a control signal CTRL_{MUX} during self-measurement operations.

The self-measurement circuit 202 may perform a self-measurement operation through four control cycles. For the first cycle, the switch SW1A may be closed and the remaining switches SW1B, SW1C and SW1D may be open. Closing the switch SW1A may drive the first stimulus voltage V_{STIM1} to the I/O terminal VIO1. This may charge the touch screen conductor coupled to the I/O terminal VIO1 to the first stimulus voltage V_{STIM1}. For the second cycle, the switch SW1B may be closed and the remaining switches SW1A, SW1C and SW1D may be open. Closing the switch SW1B may couple the I/O terminal VIO1 to the non-inverting input of the op-amp 212. A first return charge from the touch screen conductor coupled to the I/O terminal VIO1 may be captured at the non-inverting input terminal for op-amp 212. The op-amp 212 may drive the voltage across the inverting output terminal VOUTN. The voltage from the inverting output terminal VOUTN may be stored in the integrating capacitor C1.

For the third cycle, the switch SW1C may be closed and the remaining switches SW1A, SW1B and SW1D may be open. Closing the switch SW1C may drive the second stimulus voltage V_{STIM2} to the I/O terminal VIO1. This may charge the touch screen conductor coupled to the I/O terminal VIO1 to the second stimulus voltage V_{STIM2}. For the fourth cycle, the switch SW1D may be closed and the remaining switches SW1A, SW1B and SW1C may be open. Closing the switch SW1D may couple the I/O terminal VIO1 to the inverting input of the op-amp 212. A second return charge from the touch screen conductor coupled to the I/O terminal VIO1 may be captured at the inverting input terminal for op-amp 212. The op-amp 212 may drive the voltage across the non-inverting output terminal VOUTP. The voltage from the non-inverting output terminal VOUTP may be stored in the integrating capacitor C2.

The voltages stored in the integrating capacitors C1 and C2 may represent the cumulative voltages as captured during the measurement cycles. The difference between the differential op-amp 212 outputs VOUTP and VOUTN may represent the noise from the conductors of a capacitive touch screen. A processor, which is shown as processor 262, may calculate the difference between the op-amp 410 outputs VOUTP and VOUTN. The measured noise may be used by a touch screen control system (e.g., system 600 of FIG. 6) to configure operational parameters for touch detection operations, which may compensate for the measured noise.

In another embodiment, the first stimulus voltage V_{STIM1} and/or the second stimulus voltage V_{STIM2} may be the common mode voltage VCM (e.g. an AC ground voltage). Thus, in each cycle, the common mode voltage VCM may be coupled to the touch screen conductor instead of applying the first stimulus voltage V_{STIM1} and/or the second stimulus voltage V_{STIM2}. In such a configuration, the touched capacitance is not measured, only the coupled noise is measured.

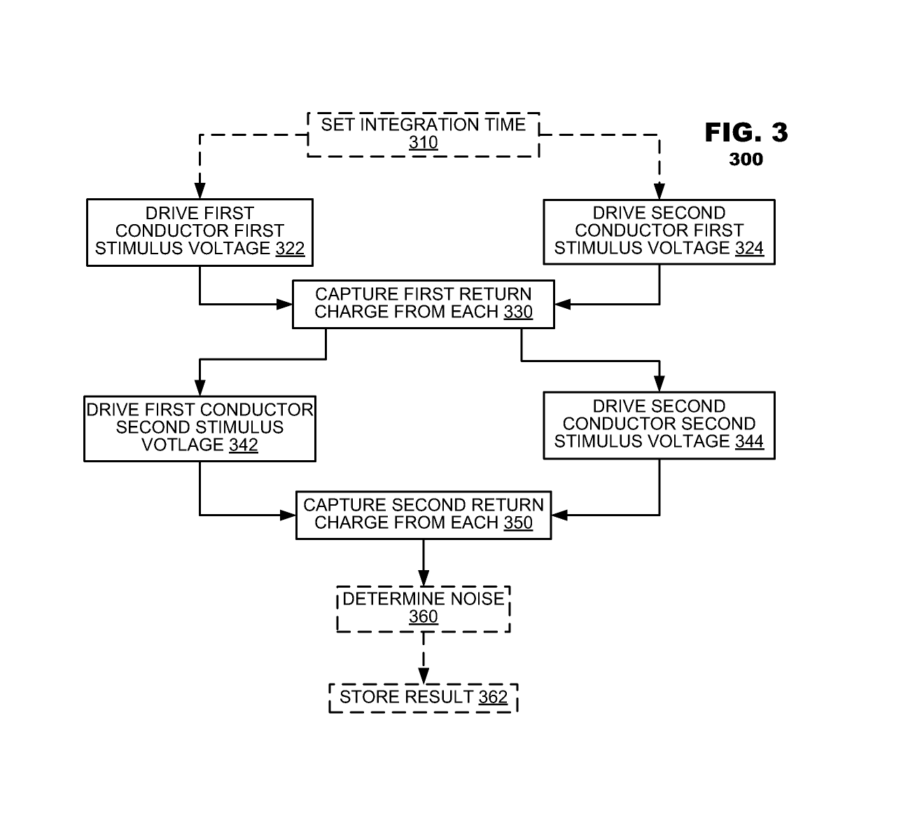

FIG. 3 illustrates a method 300 for performing a self-measurement of capacitive touch screen conductors according to an embodiment of the present invention. As illustrated in blocks 322 and 324, the method 300 may drive a first conductor first stimulus voltage and drive a second conductor first stimulus voltage to the touch screen. The method 300 may capture first respective return charges from the conductors (block 330). As illustrated in blocks 342 and 344, the method may drive a first conductor second stimulus voltage and drive a second conductor second stimulus voltage to the touch screen. The method may capture second respective return charges from the conductors (block 350).

In an embodiment, the method may estimate a coupled noise value from the respective first and second return charges (block 360). In an embodiment, the method may set an integration time for performing the self-measurement operation (block 310). The integration time may relate to a noise frequency to be measured. In an embodiment, the method may store the second result (block 372). The stored results may be used for subsequent processing operations.

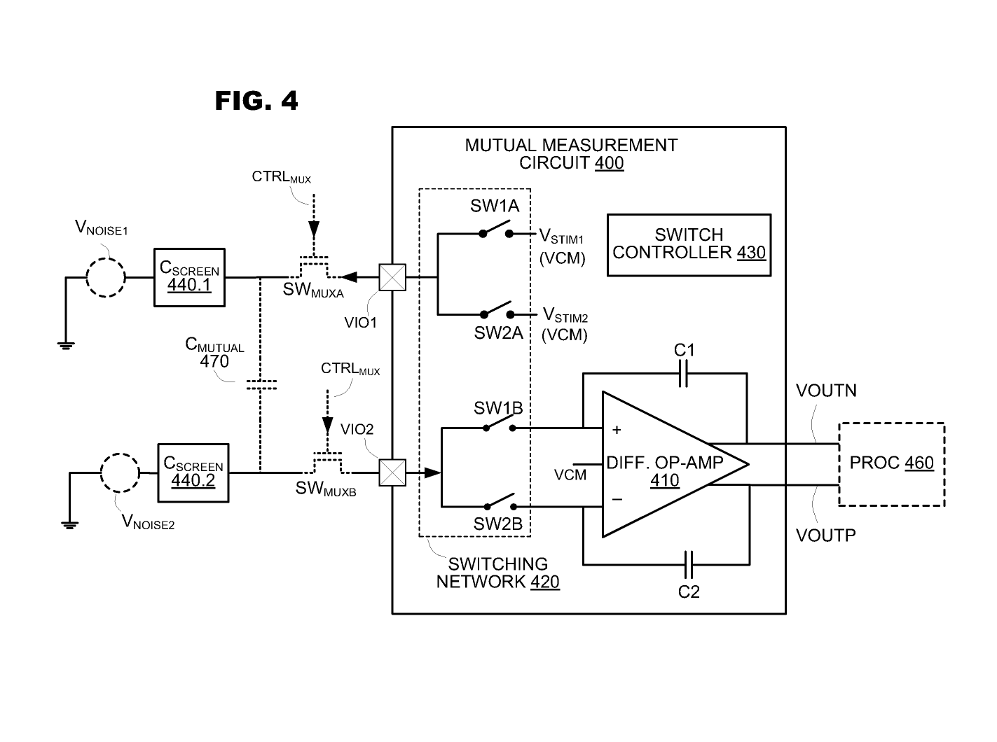

FIG. 4 illustrates a mutual-measurement circuit 400 according to an embodiment of the present invention. As illustrated in FIG. 4, the self-measurement circuit 400 may include a pair of I/O terminals VIO1, VIO2, a differential op-amp 410, and a switching network 420 operating under control of a controller 430. In the configuration illustrated in FIG. 4, the first I/O terminal VIO1 may be coupled to a first touch screen conductor, which is shown as a capacitive load C_{SCREEN} 440.2. The second I/O terminal VIO2 may be coupled to a second touch screen conductor, which is shown as a capacitive load C_{SCREEN} 440.2. A mutual capacitance C_{MUTUAL} 470 may be coupled between the capacitive load C_{SCREEN} 440.1 and the capacitive load C_{SCREEN} 440.2.

The switching network 420 may include a variety of switches, provided in pairs SW1A/SW1B and SW2A/SW2B. Within the first switch pair, switch SW1A may couple the first I/O terminal VIO1 to a first stimulus voltage V_{STIM1}. The second switch SW1B may couple the second I/O terminal VIO2 to a non-inverting input of the op-amp 410. Within the second switch pair, switch SW2A may couple the first I/O terminal VIO1 to a second stimulus voltage V_{STIM2}. The second switch SW2B may couple the second I/O terminal VIO2 to an inverting terminal of the op-amp 410. The switch controller 430 may manage the opening/closing timing of the various switches SW1A, SW1B, SW2A, and SW2B through control lines (not shown).

The op-amp 410 non-inverting input may be coupled to an inverting output VOUTN through a first integrating capacitor Cl and the inverting input may be coupled to a non-inverting output VOUTP through a second integrating capacitor C2. The capacitances for C1 and C2 may be approximately equal.

As discussed, the first touch screen conductor C_{SCREEN} 440.1 may correspond to either a row or column conductor of a capacitive touch screen to be measured by the circuit 400. The second touch screen conductor C_{SCREEN} 440.1 may also correspond to either a row or column conductor of the capacitive touch screen to be measured by the circuit 400. During operation, the mutual-measurement circuit 400 may connect to any conductor of the touch screen to measure the coupled noise present on the conductor. The mutual-measurement circuit 400 may connect to the touch screen conductors via multiplexer switches such as SW_{MUXA} and SW_{MUXB}. A capacitive touch screen control system (e.g., system 600 of FIG. 6) may manage of the switches SW_{MUXA}, SW_{MUXB} using a control signal CTRL_{MUX} during mutual-measurement operations.

The circuit 400 may perform a mutual-measurement operation through two cycles. For the first cycle, the first switch pair SW1A, SW1B may be closed to drive the first stimulus voltage V_{STIM1} to the first I/O terminal VIO1. The voltage may charge the first touch screen conductor C_{SCREEN} 440.1. Through capacitive coupling, represented by the mutual capacitance C_{MUTUAL}, the charge may be transferred to the second touch screen conductor C_{SCREEN} 440.2 and may be captured from the second I/O terminal VIO2 and applied to the non-inverting input terminal for the op-amp 410. The op-amp 410 may drive a voltage from its inverting output VOUTN across the first integrating capacitor C1.

For a second cycle, the second switch pair SW2A, SW2B may be closed to drive the second stimulus voltage V_{STIM2} to the first I/O terminal VIO1. The voltage may charge the first touch screen conductor C_{SCREEN} 440.1. Through capacitive coupling represented by the mutual capacitance C_{MUTUAL}, the charge may be transferred to the second touch screen conductor C_{SCREEN} 440.2 return charge and captured from the second I/O terminal VIO2 and applied to the inverting input terminal of the op-amp 410. The op-amp 410 may drive a voltage from its non-inverting output VOUTP across the second integrating capacitor C2.

At the conclusion of the second cycle, the difference between the op-amp 410 outputs VOUTP and VOUTN may represent the result of the mutual measurement operation. The difference may relate to the mutual capacitance C_{MUTUAL} 470 and may relate to the difference between the stimulus voltages V_{STIM1} and V_{STIM2} as driven through the first and second touch screen conductors C_{SCREEN} 440.1, 440.2. The difference may be scaled in proportion to the capacitive differences between the integrating capacitors C1 and/or C2 (capacitors C1 and C2 being approximately equal in size). A processor, which is shown as processor 460, may be included to perform calculations using the signals at the outputs VOUTP and VOUTN of the op-amp 410.

For each measurement cycle, voltage variations from coupled noise, represented by noise sources V_{NOISE1}, V_{NOISE2} may be induced on the first and second touch screen conductors C_{SCREEN} 440.1, 440.2. The coupled noise may be included in the overall result of the mutual measurement operation (the difference between VOUTP and VOUTN) as calculated at the conclusion of the second measurement cycle. Because the first and second stimulus voltages V_{STIM1} and V_{STIM2} may be known for each measurement set, the difference between VOUTP and VOUTN may be further scaled to represent the voltage variations induced by V_{NOISE1} and V_{NOISE2}. The measured noise may be used by a touch screen control system (e.g., system 600 of FIG. 6) to configure operational parameters for touch detection operations, which may compensate for the measured noise.

Further noise may be induced on the circuit 400 from bulk capacitances (not shown) that may exist in a touch screen control system (e.g., system 600 of FIG. 6). Bulk capacitances may result from capacitive coupling between various components of the touch screen control system. These system noises may be accounted for during a measurement operation using other scaling factors which may approximate the noise contributions from these noise sources. In various embodiments, multiple measurement operations may be performed to refine the noise measurements for the circuit 200. The noise measurements may be refined through a culmination of integration cycles for the integrating capacitors C1 and C2.

In another embodiment, the stimulus voltages V_{STIM1} and V_{STIM2}, shown in FIG. 4, may both be a common voltage VCM. With the common voltage VCM applied to one of the conductors of the touch screen, the conductor is kept at common voltage VCM (e.g. an AC ground voltage) while the other conductor is connected to an input of the op-amp 410 to measure the coupled noise. In such a configuration the touched capacitance is not measured. If some noise is coupled to the conductor of the touch screen that is not connected to the one of the inputs of the op-amp 410, (e.g., first touch screen conductors C_{SCREEN} 440.1) it will be swallowed by the low output impedance of the buffer that generates the common voltage VCM. Thus, the measurements of the noise at the conductor of the touch screen that is connected to the one of the inputs of the op-amp 410 (e.g., the second touch screen conductors C_{SCREEN} 440.2) will not be affected by the noise on the other conductor. These measurements can be made on both of the conductors of the touch screen, and the maximum value of the noise can be used as the representing the noise of the touch screen.

A common mode control circuit (not shown in FIG. 4) may be used to provide the common mode voltage. The common mode control circuit may be used keep the inputs of the op-amp 410 at an AC ground voltage.

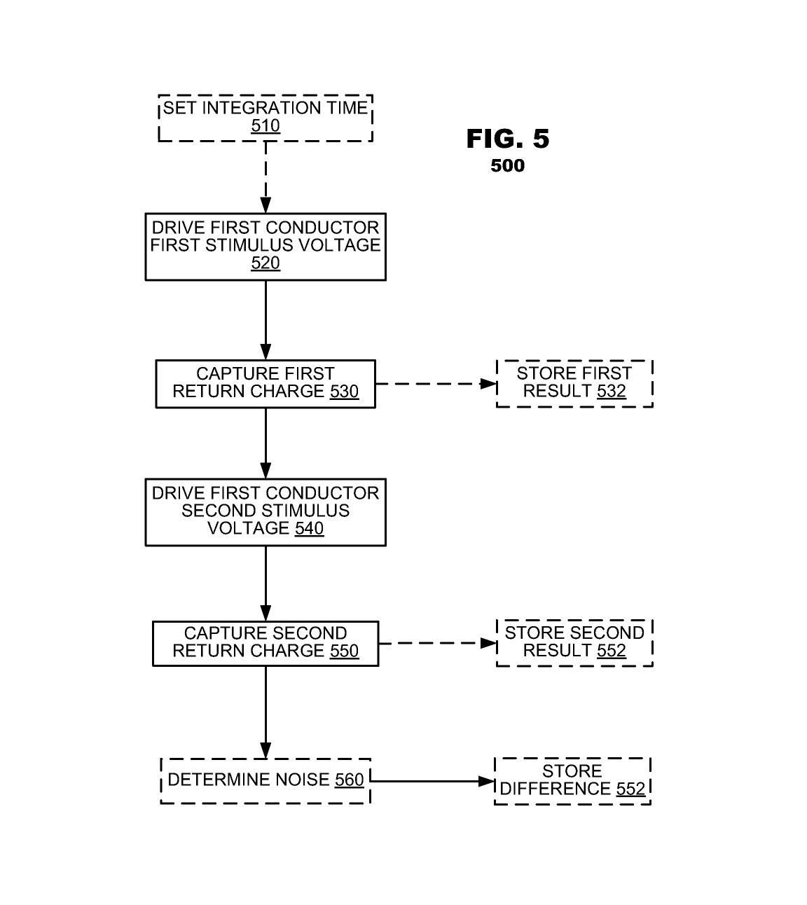

FIG. 5 illustrates a method 500 for performing a mutual measurement operation according to an embodiment of the present invention. As illustrated in block 520, the method may drive a first conductor first stimulus voltage to the touch screen. The method 500 may capture a second touch screen conductor first return charge (block 530). The method may drive a first touch screen conductor second stimulus voltage to the touch screen (block 540) and capture a second touch screen conductor second return charge (block 550). As discussed above, the first stimulus voltage and the second stimulus voltage may be the same voltage. The first and second stimulus voltage may be a common voltage VCM (e.g. an AC ground voltage).

In an embodiment, the method may estimate a noise value from the first and second return charges (block 560). In an embodiment, the method may set an integration time for performing the mutual-measurement operation (block 510). In an embodiment, the method may store the first captured return charge (block 532). In an embodiment, the method may store the second captured return charge (block 552). In another embodiment, the method may store the result of the mutual-measurement operation for use in subsequent processing operations (block 562).

FIG. 6 illustrates a control system 600 for a capacitive touch screen 650 according to an embodiment of the present invention. The system may control measurement operations and touch detection operations for the touch screen 650. The control system 600 may include a processor 610, a measurement sub-system 620, a detection sub-system 630, and routing fabric shown as a multiplexer (“MUX”) 640. The processor 610 may manage operation of the system 600. The routing fabric MUX 640 may couple the control system 600 to column and row conductors of the touch screen 650 through I/O terminals VIO_{COL}, VIO_{ROW}. The processor 610 may control the coupling of the MUX 640 to row or column conductors of the touch screen 650 through a control signal CTRL_{MUX} for the measurement and touch detection operations. The control system 600 may be incorporated into an integrated circuit (“IC”).

The measurement sub-system 620 may include associated circuitry for self-measurement circuits as discussed in FIG. 1A and FIG. 2 and/or mutual-measurement circuits as discussed in FIG. 1B and FIG. 4. The measurement system 620 may drive a plurality of signals to conductors of the touch screen 650 and receive return signals from touch screen conductors for measurement operations.

The detection sub-system 630 may include signal generators to generate excitation signals having unique spectral characteristics that may be driven to conductors of the touch screen 650. The detection sub-system 630 may also include analog-to-digital converters, digital filters, and/or analog filters to sample and condition return signals received from conductors of the touch screen 650.

The processor 610 may manage the measurement sub-system 620 and the detection sub-system 630 to perform noise-compensated touch detection operations for the touch screen 650. For detection operations, detection system 630 may generate excitation signals that may be driven to conductors of the touch screen 650. By controlling MUX 640, the processor 610 may determine which conductors (row or column) the excitation signals may drive. Signals returned from the touch screen 650 may be sampled by the detection system 630 and communicated to the processor 610. The processor 610 may decode the signals, determine if touches have occurred, and/or determine touch locations. The return signals may also include coupled noise that may be induced on the touch screen 650. The system 600 may perform measurement operations using the measurement system 620 to measure the coupled noise. The measured noise may be used to adjust operational parameters for the system 600, which may compensate for the noise during touch detection operations. The operational parameter adjustments may include adjusting frequencies for the excitation signals that the detection system 640 may generate and drive to the touch screen 650. The operational parameter adjustments may also include adjusting the sampling rate (integration time) for which the receiver 630 may sample the return signals from the touch screen 650.

For example, say a 120 Hz noise frequency may be induced on a touch screen control system 600 from a switched mode power supply. The detection sub-system 630 may drive excitation signals to the touch screen 650 at frequencies other than 120 HZ (e.g., 60 HZ) to add a notch at the interference frequency and avoid interference from the noise frequency. On the receiving side, the detection sub-system 630 may sample return signals received from the capacitive touch screen 650 at a rate or frequency proportional to the 120 Hz noise frequency. Sampling the return signals in this manner may minimize the 120 Hz noise components present on the return signals. As a result, the sampled signals may more accurately represent signal changes due to touches performed on the screen 650 rather than signal changes induced by coupled noise frequencies.

As discussed, the system 600 may perform detection and measurement operations using a predetermined integration time. For detection operations, the integration time may relate to the frequencies of excitation signals that may be driven to the touch screen 650 and the sampling rate for sampling the return signals received from the touch screen 650. For measurement operations, the integration time may relate to a frequency of noise that the system 600 may measure—the inverse of the integration time may equal the noise frequency to be measured. The integration time may be used to control the switching rate of the switching networks for the self and mutual-measurement circuits. The integration time may also be used to control the sampling rate for passive noise measurement operations. Passive measurement operations may include capturing ambient return signals from conductors of the touch screen in the absence of driving stimulus voltages to the screen.

Optimum Integration Time Selection

In an embodiment, the integration time may be to determine an optimum integration time for operation of the system 600. At the optimum integration time, interference from noise in the system may be minimized. The optimum integration time may be determined by measuring noise at a various integration times, and selecting an integration time that results in a minimum measured noise. A range of integration times may be predetermined for the system. The system 600 may cycle through the range to determine the optimum integration time.

To begin, the system may measure noise at an initial integration time. The system may repeat the noise measurement at an integration time that is incremented. The measurement of the noise may be repeated at multiple incremented integration times to find a local minimum for the measured noise. The integration time at the local minimum may be used as the starting point to calculate other possible integration times that minimize the effect of noise.

The system may calculate subsequent integration times using a frequency hopping technique and measure noise at each offset integration time. The system 600 may continue to measure noise at each calculated integration time until the predetermined range of integration times is exhausted. Measuring noise at the calculated integration times may provide for refinement of the optimum integration time for the system 600. The system may perform frequency hopping calculations to according to the following equation:

$$\text{?} = ( 1 + \frac{1}{N} ) φ . \\ \text{?} \text{indicates text missing or illegible when filed} \qquad Eqn . 1$$

For Eqn. 1, each calculation of φ may represent an integration phase time and the variable “N” may relate to a number of integration cycles (measurement operations). As discussed above, multiple integration cycles may be used to improve the rejection of noise for a certain integration time. If a noise measurement at a calculated integration time may be lower than the temporary noise threshold, the system may update the temporary noise threshold and store the integration time corresponding to the noise measurement. The system 600 may continue to measure noise across the predetermined range of integration times. After the predetermined range of integration times is exhausted, the optimum integration time may be set to the stored integration time from the noise measurements. For subsequent detection operations, the optimum integration time may be used to sample touch inputs.

In an embodiment, the system 600 may perform frequency hopping noise measurements during touch detection operations. During touch detection operations, noise may be actively measured from signals returned from the capacitive touch screen. If noise may be detected in the return signals, the system 600 may perform frequency hopping calculations to update the optimum integration time for the system. The system may calibrate parasitic capacitance for the conductor crosspoints following the frequency hopping noise measurements.

Parasitic Capacitance Calibration

In various embodiments, the system 600 may adjust operation of the touch screen 650 based on parasitic capacitances that may exist about crosspoints between row and column conductors. Parasitic capacitances may exist due to unsettled activity of the conductors as the system may measure noise using different integration times. Parasitic capacitance calibration may be performed following selection of an optimum integration time to determine a parasitic capacitance factor for each conductor crosspoint of the touch screen 650. Proper calibration for each conductor crosspoint may be performed if the conductor is not being touched and the noise for the conductor is below a predetermined noise threshold. The parasitic capacitance factor may be used to more accurately resolve touch locations by minimizing system offset errors for each conductor crosspoint and thus providing more accurate touch measurements.

To perform a parasitic capacitance calibration, the system may measure the capacitance of an initial touch screen conductor. The capacitance may be compared to a predetermined capacitance threshold to determine if the conductor is being touched. A measured capacitance above the threshold may indicate that the conductor is being touched, in which case the system may approximate the parasitic capacitance for each crosspoint of the conductor (discussed below). A measured capacitance below the capacitance threshold may indicate that the conductor is not being touched, in which case the system 600 may measure noise for the conductor using the optimum integration time. The noise for a given conductor may be compared to a predetermined noise threshold. The noise may be measured for a conductor and compared against the noise determined to be the local minimum at multiple incremented integration times.

If the noise is below the threshold, the conductor likely is untouched, and the system 600 may calibrate a parasitic capacitance factor for each crosspoint along the conductor. If the noise is above the threshold, the conductor likely is being touched, in which case the parasitic capacitance factor for each crosspoint may be approximated using an average of the parasitic capacitance factors for other touch screen conductors that are assessed as untouched. The parasitic capacitance factor for each touch screen 650 conductor may be adjusted in this manner. If a sensor is untouched and it is not noisy, the measurement of capacitance performed by the system is the parasitic capacitance itself, therefore the equivalent charge for that capacitor may be subtracted at the input of the opamp, thus compensating for that capacitance value.

In an embodiment, the system 600 may store the capacitance data for each conductor as measured during parasitic capacitance calibrations. The noise data may be used during touch detection operations to provide adaptive capacitance thresholds for various conductor crosspoints that may be touched during a touch operation. The adaptive thresholds may provide for pre-processing return signals from the capacitive touch screen to determine if an actual touch may be performed or if the conductor may merely be noisy. Capacitance values for conductor crosspoints may be calculated from the return signals. The capacitance values may be compared to the adaptive capacitance threshold. If the calculated capacitance for the return signal is above the threshold the system 600 may determine that the conductor is being touched. The system 600 may then resolve the location of the touch(es). If it is below the threshold, then the system may determine that the conductor is merely noisy, in which case processing for touch locations may be bypassed. In an embodiment, the adaptive threshold may be proportional to the average capacitance threshold for a predetermined group of crosspoints about a conductor.

The system 600 may allow for dynamic combination of self, mutual, and/or passive measurement operations with frequency hopping operations, parasitic capacitance calibrations, and/or adaptive threshold operations to compensate for various coupled noise frequencies depending on various applications for the touch screen control system 600.

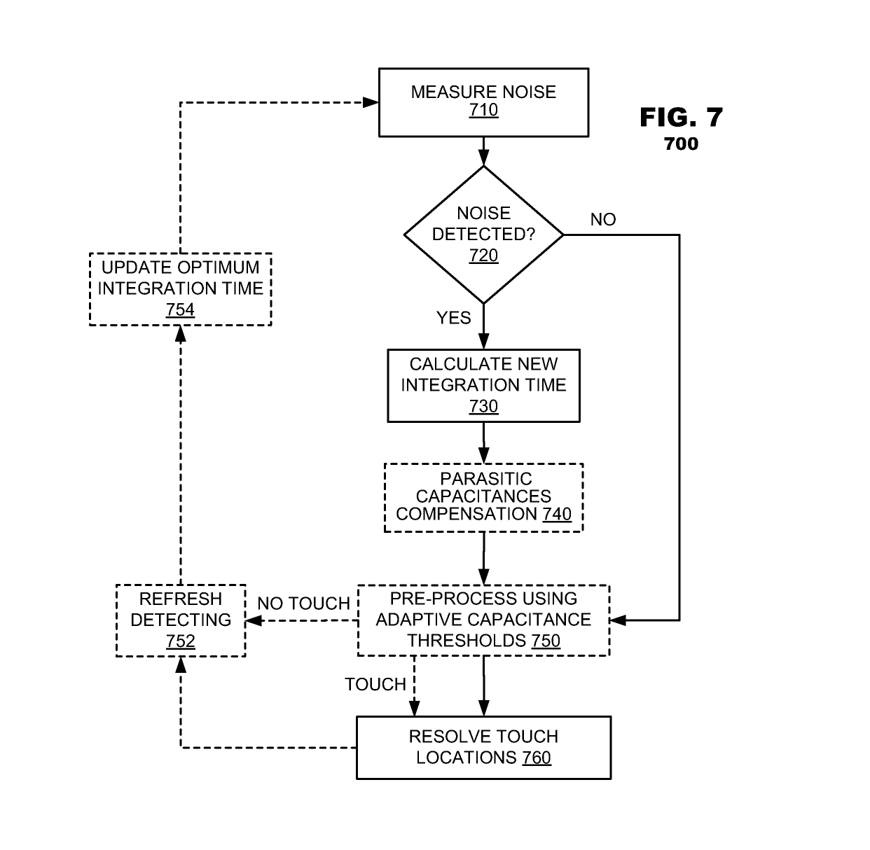

FIG. 7 illustrates a method 700 for detecting touch operations performed on a capacitive touch screen system according to an embodiment of the present invention. The method 700 may detect a touch on the touch screen system while minimizing the effect noise that is detected in the touch screen system.

As illustrated in FIG. 7, the method 700 may measure the noise of the touch screen system (block 710). The measured noise may be compared to a threshold (block 720). If the measured noise is equal to or above the threshold (YES in block 720), then it is determined that noise is detected and noise compensation can be performed. If the measured noise is below the threshold (NO in block 720), then it is determined that the noise is not significant (e.g., no need to determine new integration phase time and/or perform parasitic capacitance compensation). If the noise is detected (YES in block 720), then a new integration phase time may be calculated (block 730). The method 700 may also include compensation for parasitic capacitance compensation (block 740). The signals from the one or more of the touch screen conductors may be pre-processed to determine if a touch is present (block 750). If the touch is present, the method 700 may resolve touch locations (block 750) for touch operations that may occur on the capacitive touch screen.

Calculating the new integration phase time and/or the parasitic capacitance may include injecting excitation signals into one or more of the touch screen conductors and sampling return signals from the one or more of the touch screen conductors. In an embodiment, the method 700 may compensate for parasitic capacitances for each conductor crosspoint of the touch screen following determination of an optimum integration time.

In another embodiment, the method 700 may pre-process the return signals using adaptive capacitive thresholds to determine if a conductor is being touched or if it is noisy. If the pre-processing determines that the conductor is being touched, the method 700 may resolve locations for the touch(es). Otherwise, the method may refresh the detecting (block 752). The method 700 may perform the frequency hopping measurements and the parasitic capacitance calibrations using mutual measurement and/or self-measurement operations as discussed above.

In an embodiment, the method may refresh the detecting of touch operations (block 752). In another embodiment, the method 700 may update the optimum integration time for the system (block 754).

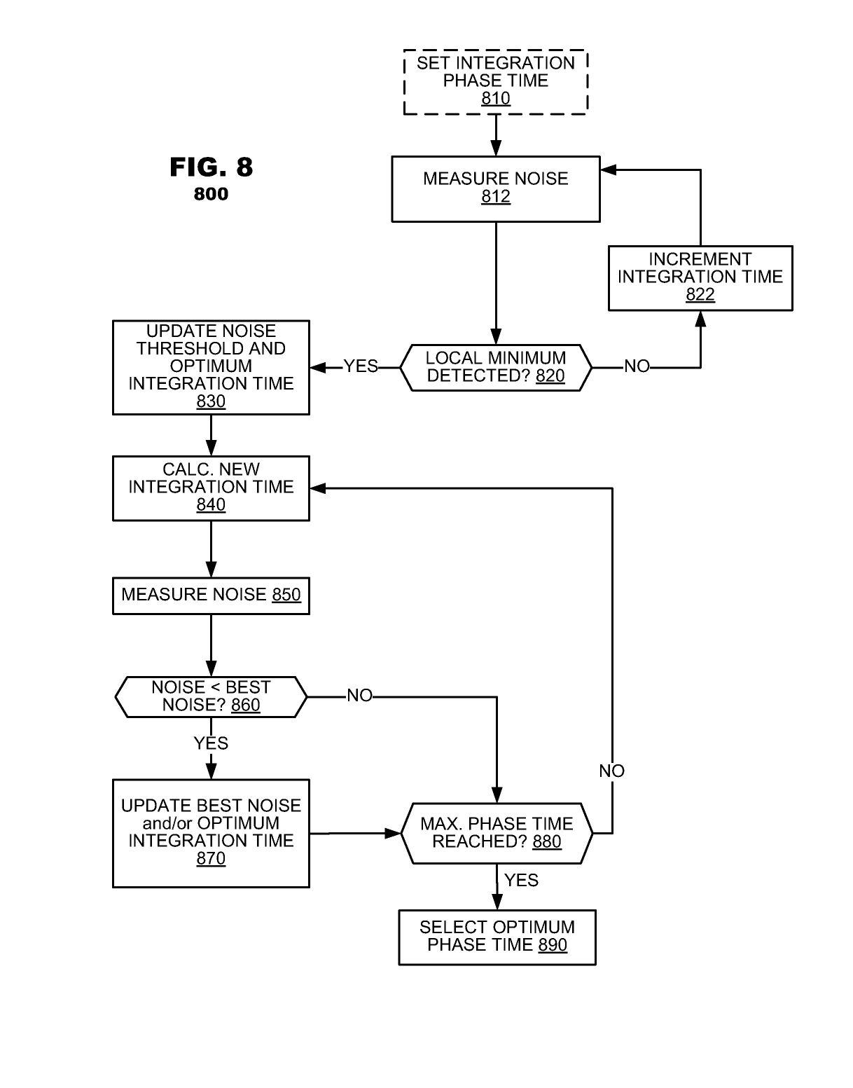

FIG. 8 illustrates a method 800 for determining an optimum integration time for operation of a capacitive touch screen system according to an embodiment of the present invention. The method 800 may determine the optimum integration time by measuring noise across a predetermined range of test integration times. The 800 may be performed if noise of the touch screen system exceeds a predetermined threshold. The method may include determining all of the local minimum of noise for a range of integration time and selecting the integration time that corresponds to the lowest noise measurement.

As shown in FIG. 8, the method 800 may set the integration time to a first value (block 810). The first value may be a minimum integration phase time. At the first integration time, the measure noise from touch screen conductors may be measured (block 812). The measured noise may be used to determine if the noise is a local minimum (block 820). If the measured noise is not a local minimum (NO in block 820), then the integration phase time may be incremented (block 822) and perform another noise measurement operation (return to block 810).

If the measured noise is a local minimum (YES in block 820), the method 800 may set the noise threshold to the measured noise level and set the optimum integration time to the integration time corresponding to the measured noise (block 830). The method may calculate a new local minimum of the noise at the next integration time (block 840). The method may measure noise from the one or more touch screen conductors according to the calculated integration time (block 850). The method may compare the measured noise to the best noise value (block 860). The best value may be a noise value with the least amount of noise.

If the measured noise is less than the best noise value, the method 800 may set the best noise value to the measure noise and/or set the optimum phase time to the current phase time (block 870). If the integration time is exceeds the best noise value or after setting the new value for the best noise value (block 870), the method may determine if the maximum phase time has been reached (block 880). If the maximum phase time has been reached (YES in block 880), then the current optimum phase time may be used for the operation of the touch screen system. If the maximum phase time has not been reached (NO in block 880), a new local minimum can be calculated at the next phase time (block 840).

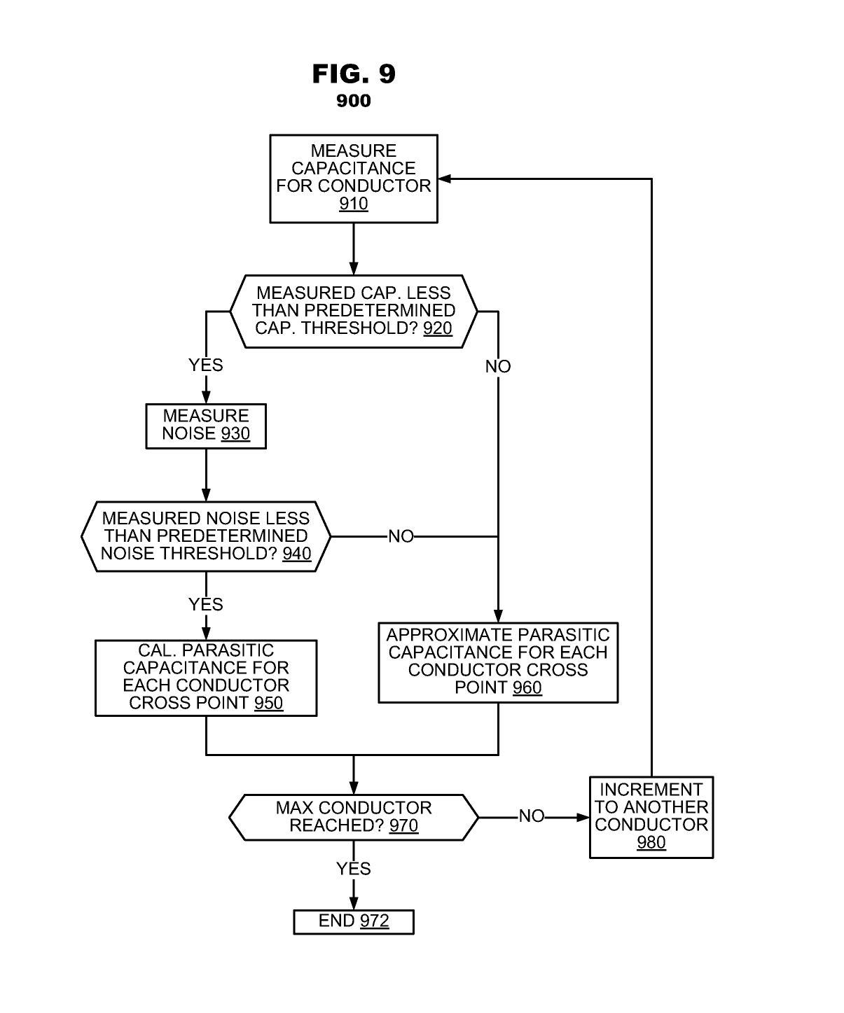

FIG. 9 illustrates a method 900 for performing parasitic capacitance calibrations according to an embodiment of the present invention. The method 900 may measure the capacitance for a first touch screen conductor (block 910). The method 900 may compare the measured capacitance against a predetermined capacitance threshold (block 920). If the measured capacitance exceeds the threshold, the method may approximate a parasitic capacitance factor for each crosspoint of the conductor (block 960). If the measured capacitance is less than the capacitance threshold, the method 900 may measure the noise for the conductor (block 930). The method 900 may compare the measured noise against a predetermined noise threshold (block 940). If the measured noise is less than the predetermined noise threshold, the method 900 may calibrate a parasitic capacitance factor for each crosspoint of the conductor (block 950). If the noise exceeds the predetermined threshold, the method 900 may approximate a parasitic capacitance factor for each crosspoint of the conductor (block 960).

The method 900 may check if the touch screen conductor is equal to a maximum number of touch screen conductors (block 970). If it is not, the method may increment to a subsequent touch screen conductor (block 980) and repeat the measuring capacitance and noise for the subsequent conductor (return to block 910). Otherwise, the method 900 may end (block 972).

In an embodiment, the predetermined noise threshold may be set to the noise threshold as set during the selection of an optimum integration time and/or frequency hopping noise measurements. In an embodiment, the method 900 may approximate the parasitic capacitance factor for each crosspoint of the conductor. The approximation may be set to an average capacitance factor for conductors having measured noise below the predetermined noise threshold. In an embodiment, the method 900 perform self-measurement operations to measure the noise for each touch screen conductor.

Several embodiments of the present invention are specifically illustrated and described herein. However, it will be appreciated that modifications and variations of the present invention are covered by the above teachings. In other instances, well-known operations, components and circuits have not been described in detail so as not to obscure the embodiments. It can be appreciated that the specific structural and functional details disclosed herein may be representative and do not necessarily limit the scope of the embodiments.

Those skilled in the art may appreciate from the foregoing description that the present invention may be implemented in a variety of forms, and that the various embodiments may be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims.

We claim:

1. A method for detecting touch operations performed a capacitive touch screen system, comprising:
determining an optimum integration time for control sampling touch screen conductors, wherein the optimum integration time compensates for noise on the touch screen conductors;
injecting excitation signals to conductors of the capacitive touch screen;
sampling return signals from the conductors; and
resolving touch locations based on profiles for the return signals.

2. The method of claim 1, further comprising calibrating parasitic capacitances for conductor crosspoints.

3. The method of claim 2, further comprising comparing the return signals to adaptive capacitance thresholds to determine if a conductor crosspoint is being touched,
if the crosspoint is being touched, resolving touch locations based on the return signals, and
if the crosspoint is not being touched, bypassing the resolving touch locations and repeating the injecting and sampling.

4. The method of claim 3, wherein an adaptive capacitance threshold is set using an average capacitance value from a predetermined group of conductor crosspoints.

5. The method of claim 1, further comprising performing frequency hopping noise measurements on the return signals from the conductors for updating the optimum integration time.

6. The method of claim 1, further comprising repeating the injecting, sampling, and resolving touch locations for a predetermined number of operation cycles.

7. The method of claim 1, further comprising repeating the determining an optimum integration time, injecting, sampling, and resolving touch locations for a predetermined number of operation cycles.

8. A method for determining an optimum integration time for control of touch screen conductor measurement circuits, comprising:
measuring noise from a capacitive touch screen for a plurality of integration times within a range of integration times;
determining one or more local minimums for the measure noise at the plurality of integration times; and
setting the optimum integration time to an integration time corresponding to the lowest local minimum.

9. The method of claim 8, wherein the integration time is calculated according to Eqn. 1.

10. The method of claim 8, further comprising incrementing the integration time within the range of integration times from a minimum value to a maximum value.

11. A method for calibrating parasitic capacitances for touch screen conductor crosspoints, comprising:
on an iterative basis for each conductor of the touch screen:
measuring capacitance for a conductor;
comparing the measured capacitance against a predetermined capacitance threshold;
if the measured capacitance is above the threshold, approximating the parasitic capacitance for each crosspoint of the conductor;
if the measured capacitance is below the predetermined capacitance threshold,
measuring noise for the conductor,
comparing the noise to a predetermined noise threshold,
if the measured noise is above the predetermined noise threshold, approximating the parasitic capacitance for each crosspoint of the conductor, and
if the measured noise is below the predetermined noise threshold, calibrating the parasitic capacitance for each crosspoint of the conductor.

12. The method of claim 11, wherein the approximated parasitic capacitance for each crosspoint of the conductor is set to an average parasitic capacitance value of other conductor crosspoints having measured noise below the predetermined noise threshold.

13. A measurement system, comprising:
driver circuits to drive stimulus signals to a pair of circuit terminals for connection to touch screen conductors;
sampling units to capture return signals from the terminals; and
a processor to estimate noise on the touch screen conductors based on the return signals.

14. The system of claim 13, wherein the driver circuits each comprise a pair of switches coupling respective terminals to respective stimulus voltages.

15. The system of claim 13, wherein the sampling units each comprise a pair of switches, a first switch coupling a respective terminal to a first input of an operational amplifier and a second switch coupling the respective terminal to a second input of the operational amplifier.

16. The system of claim 13, further comprising a multiplexer selectively coupling the circuit terminals to the touch screen conductors.

17. The system of claim 13, wherein the processor includes an analog-to-digital converter.

18. A measurement system, comprising:
a driver circuit to drive stimulus voltages to a first terminal connected to a first touch screen conductor; and
a sampling unit to capture return charges from a second terminal connected to a second touch screen conductor, the return charges being captured while the stimulus voltages are driven to the first touch screen conductor; and
a processor to estimate noise of the first conductor and second conductor based on the return charges.

19. The system of claim 18, wherein the driver circuit comprises a pair of switches coupling the first terminal to respective stimulus voltages.

20. The system of claim 18, wherein the sampling unit comprises a pair of switches, a first switch coupling the second terminal to a first input of an operational amplifier and a second switch coupling the second terminal to a second input of the operational amplifier.

21. The system of claim 18, further comprising a multiplexer selectively coupling the circuit terminals to the touch screen conductors.

22. A measurement circuit for measuring noise from capacitive touch screen conductors coupled to I/O terminals of the measurement circuit, comprising:
a differential operational amplifier (op-amp) having a pair of inputs and a pair of outputs;
integrating capacitors each coupling a respective op-amp output to an op-amp input; and
a switching network having a plurality of switches connecting a first I/O terminal to each of a pair of stimulus voltages, and connecting a second I/O terminal to each op-amp input.

23. The circuit of claim 22, wherein the switching network operates in four phases:
a first phase driving a first stimulus to the first I/O terminal;
a second phase capturing a charge at the second I/O terminal at a first op-amp input;
a third phase driving a second stimulus voltage to the first I/O terminal; and
a fourth phase capturing a charge at the second I/O terminals at a second op-amp input.

24. The circuit of claim 22, further comprising a multiplexer selectively connecting the I/O terminals to various touch screen conductors.

25. The circuit of claim 23, wherein the phases are performed according to an integration phase time.

26. The circuit of claim 22, further comprising a switch controller to control the switching network.

27. A method for measuring noise from conductors of a capacitive touch screen, comprising:
in a first measurement cycle:
driving respective stimulus signals to first and second touch screen conductors;
capturing return signals from the first and second touch screen conductors;
in a second measurement cycle:
driving respective stimulus signals to the first and second touch screen conductors;
capturing return signals from the first and second touch screen conductors;
comparing the return signals of the two measurement cycles; and
estimating noise on the touch screen conductors based on the comparison.

28. The method of claim 27, further comprising using the measured noise to configure the operational parameter of the capacitive touch screen.

29. The method of claim 27, wherein the capturing comprises routing return signals from the touch screen conductors to inputs of an operational amplifier and wherein the comparison is performed by the operational amplifier.

30. The method of claim 27, wherein the capturing comprises digitizing the return signals and comparing the digitized signals.

31. A method for measuring noise from conductors of a capacitive touch screen, comprising:
in a first measurement cycle:
driving a first stimulus signal to a first touch screen conductor;
capturing a return signal from a second touch screen conductor;
in a second measurement cycle:
driving a second stimulus signal to the first touch screen conductor;
capturing a return signal from the second touch screen conductor;
comparing the return signals of the two measurement cycles; and
estimating noise on the first and second touch screen conductors based on the comparison.

32. The method of claim 31, wherein the capturing comprises routing the return signal from the second touch screen conductor to an input of an operational amplifier and wherein the comparison is performed by the operational amplifier.

33. The method of claim 31, wherein the capturing comprises digitizing the return signal and comparing the digitized signals.

34. A touch screen control system for a capacitive touch screen, comprising:
a measurement system to drive stimulus signals to capacitive touch screen conductors and capture return signals from the conductors;
a detection system, comprising a plurality of signal generators, each to generate and drive an excitation signal having a unique spectral profile to conductors of the capacitive touch screen, and at least one analog-to-digital converter to sample return signals from conductors of the capacitive touch screen; and
a processor to estimate noise on the conductors based on the measurement system return signals, and to determine touch locations based on the detection system return signals.

35. The system of claim 34, wherein the measurement system and detection system are coupled to various touch screen conductors through routing fabric.

36. The system of claim 34, wherein the processor configures a sampling rate for the at least one analog-to-digital converter based on noise estimations.

37. The system of claim 34, wherein the processor configures the spectral profiles of the excitation signals based on noise estimations.

38. The system of claim 34, wherein the processor calculates noise from a noise estimation according to Eqn. 1.

39. A method for measuring noise from conductors of a capacitive touch screen, comprising:
coupling a first touch screen conductor to a common mode voltage;
capturing a first return signal from a second touch screen conductor and a second return signal from the second touch screen conductor;
comparing the first and second return signals; and
estimating noise on the first and second touch screen conductors based on the comparison.

40. A method for measuring noise from conductors of a capacitive touch screen, comprising:
in a first measurement cycle:
coupling a first touch screen conductor to a common mode voltage, and
capturing a return signal from a second touch screen conductor at an inverting input of an op-amp;
in a second measurement cycle:
coupling the first touch screen conductor to the common mode voltage, and
capturing a return signal from the second touch screen conductor at a non-inverting input of an op-amp;
comparing the return signals of the two measurement cycles; and
estimating noise on the first and second touch screen conductors based on the comparison.

41. A method for measuring noise from conductors of a capacitive touch screen, comprising:
in a first cycle:
coupling a touch screen conductor to a common mode voltage;
in a second cycle:
capturing a return signal from the touch screen conductor, and
providing the return signal to a non-inverting input of an op-amp;
in a third cycle:
coupling the touch screen conductor to the common mode voltage;
in a fourth cycle:
capturing a return signal from the touch screen conductor, and
providing the return signal to an inverting input of the op-amp; and
estimating noise on the touch screen conductor based on the return signals from the second and fourth cycles.

42. A touch screen control system for a capacitive touch screen, comprising:
a measurement system to provide a common mode voltage to at least one of the capacitive touch screen conductors and capture return signals from at least one of the conductors;
a detection system, comprising at least one analog-to-digital converter to sample signals from conductors of the capacitive touch screen; and
a processor to estimate noise on the conductors based on the measurement system signals, and to determine touch locations based on the detection system return signals.
